(19) United States
(12) Patent Application Publication
(10) Pub. No.: US 2018/0349975 A1
(43) Pub. Date: Dec. 6, 2018

(54) SYSTEM AND METHOD OF FACILITATING CONSUMER-ASSISTED VEHICLE SALES PLATFORM

(71) Applicant: Sung Hyun Lee, State College, PA (US)

(72) Inventor: Sung Hyun Lee, State College, PA (US)

(21) Appl. No.: 15/992,934

(22) Filed: May 30, 2018

Related U.S. Application Data
(60) Provisional application No. 62/512,629, filed on May 30, 2017.

(51) Int. Cl. G06Q 30/06; G07C 5/00; G06Q 30/02

(52) U.S. Cl. CPC G06Q 30/0627; G06Q 30/0641; G06Q 30/0271; G07C 5/008

(57) ABSTRACT

A system comprising a processor is programmed to receive vehicle data from a plurality of vehicles, user data of customers and user data of promoters who are offering his vehicle for test drive. The system allows the customers to find vehicles available for test drive based on a search query generated using the user data that includes the customer's driving profile. The test drive vehicles matching the search query is identified based on the vehicle data of the vehicles, in which at least some of the usage profile of the vehicle is originated from the vehicle computer, telematics system or sensors provided in the vehicle. The promoters availing his own vehicle for test drive by customers are rewarded upon verification of a successful completion of a test drive event.

### REFERENCE TO RELATED APPLICATIONS

This application claims the priority benefit of U.S. provisional Patent Application No. 62/512,629, entitled “Offline to Online in Auto Industry”, filed on May 30, 2017, the entire contents of which are incorporated herein by reference.

### FIELD OF THE INVENTION

The illustrative embodiments generally relate to utilizing a vehicle computer system for facilitating geographically oriented vehicle test drive platform for potential vehicle purchasers.

### BACKGROUND OF THE INVENTION

Generally, vehicles are sold through two channels: offline and online. Offline channel, i.e., vehicle dealer shop, has been the primary sales channel for automobile industry. Typically, customers walk in to a vehicle dealership for any inquiries regarding the desired vehicle or for making purchases. The online sales channel for the vehicle industry has definitely made it much more convenient for the customers to obtain information regarding the desired vehicles, but the vehicle industry has not fully embraced the potential features that can be implemented via the online sale channel.

As vehicle industry is primarily relying on the offline sale channel, vehicle manufacturers forecast sales in the market for each model. Then, the vehicle manufactures prepares to stock the forecasted number of vehicles. In this regards, most vehicle manufacturers fills up the stock on hand to ensure that it does not lose any market shares due to the lack of their own inventories. With various optional features available for a vehicle, however, it is very difficult for the vehicle manufacturers to forecast appropriate inventory size for each available option of a vehicle. All dealerships' wish to maintain at least some inventories for each of the available options of a vehicle to ensure that it can meet any customer's needs; test drives, upgrades, and immediate purchases. Not only does ensuring the availability of various models require increased inventory carrying costs for the vehicle manufacturer, it also requires the vehicle dealers to have a large lot to hold the inventories, which in turn, increases the operating cost of the dealership as well.

Although the online website of the vehicle manufactures can provide certain information regarding the variety of options available for each vehicle model, many customers still prefer to see the actual vehicle with the desired features/options. Accordingly, a system is needed that serves both the consumer and the vehicle manufactures; and which allows potential new customers to actually view and test drive desired vehicles while keeping the inventory carrying cost and other business operating cost of the vehicle manufactures down. The vehicle sales assistance system may also enable consumers to see and experience the vehicle, not just in a showing room condition, but those maintained in various states which may mimic the consumer's own vehicle maintenance or driving style.

### SUMMARY OF THE INVENTION

A first illustrative embodiment discloses a method of operating a consumer-assisted vehicle sales platform. First, vehicle data and customer data are built. The vehicle data is built for each of the vehicles available for a trial (e.g., test drive). Each vehicle data includes a usage profile of the respective vehicle, which is made of a set of operating parameters associated with the respective vehicle. At least one or more of operating parameter values of the set are collected from one or more on-board sensors equipped in the respective vehicle. Customer data is built for each customer. The customer data includes a driving profile of the customer associated with the respective customer data. The driving profile comprises a set of operating parameters with respect to the customer, in which at least one or more of operating parameter values are collected from one or more sensors of the user terminal associated with each respective customer. When a customer sends a search query, vehicles satisfying the search query are identified and presented. Here, the search query is at least in part structured to identify the vehicles having the usage pattern that is similar to the customer's driving profile. The similarity between the usage pattern of the vehicle and the driving profile of the customer can be determined based on the comparison of the set of operating parameters in the usage profile and the driving profile. Once the vehicles satisfying the search query are identified, the result is presented to the customer who sent the search query so that the customer can send a request for a trial to the user terminal of the promoter associated with the customer's selected vehicle. The promoter can accept the request to schedule the trial of the vehicle.

The set of operating parameters may include parameters indicative of basic operation profile, frequently traveled route profile, acceleration profile, deceleration profile, velocity profile and maintenance profile (diagnostic/checkup frequency). The basic operation profile represents the current status information of the respective vehicle, including but not limited to, cumulative total mileage, average/current travel distance per trip, fuel economy, weather condition at the location of the vehicle, etc. The frequently traveled routes profile represents information regarding the frequently used route between frequent origins and destinations. For example, the frequently traveled route profile may include information as to the highway traveled distance/duration, local roads traveled distance/duration, ratio of highway to local travel, information as to the traffic condition on those frequently traveled routes, information as to road conditions of the frequently traveled routes, number of road bumps in each of the frequently traveled routes, uphill/downhill on the frequently traveled routes, etc. The acceleration profile includes information regarding vehicle's acceleration records from stationary to a predetermined cruising speed(s) and between certain ranges of speed, such as RPMs during acceleration, torque during acceleration, etc. The deceleration profile includes information regarding vehicles deceleration records from a predetermined cruising speed(s) to a full stop and between certain ranges of speed, breaking frequency, etc. The velocity profile includes information such as average velocity on the frequently traveled routes, average velocity on each type of roads, average velocity during each type of weather conditions, etc. The maintenance profile includes information such as those describing whether or not a vehicle's components (e.g., headlights or windshield wipers) are in operation, information describing the tire pressure in the vehicle's tires, information describing the amount of fuel in the vehicle's gas tank, and other information collectable from the on-board-diagnostic system. The maintenance profile may further includes results from the diagnostic test performed by the on-board vehicle computer as well as service frequency and the past diagnostic test results obtained from the service centers.

A second illustrative embodiment discloses a consumer-assisted vehicle sales system. The system includes one or more network interfaces (e.g, Bluetooth, WiFi, WAN, wired, etc), which facilitates communications between a customer's user terminal and a promoter's user terminal (e.g., smartphone, table and/or other network enabled computing device). Each of the customer's user terminal and the promoter's user terminal includes one or more processors that are configured to perform a plurality of functions. The one or more processors in the promoter's user terminals are configured to build vehicle data for the vehicle associated to each respective promoter. The vehicle data includes, among other things, a usage profile which is made of a set of operating parameters of the respective vehicle. At least some of the set of operating parameters in the usage profile are based on the operating parameter values obtained from one or more on-board sensors of the respective vehicle. The operating parameter values from the on-board sensors may be combined or processed in conjunction with information collected from other data sources and included as the set of operating parameters in the usage profile. For instance, the data obtained from the navigation system can be combined with the acceleration/deceleration/speed profile to obtain acceleration/deceleration/velocity profile for the frequently traveled routes. The one or more processors provided in the promoter's user terminal may further be configured to build the promoter user data of the respective promoter. The promoter user data includes, among other information, a promoter driving profile, which is based on the set of operating parameters. At least some of the set of operating parameters based on one or more operating parameter values collected from one or more sensors provided in the respective promoter's user terminal, such as a GPS sensor, a magnetometer, an accelerometer, a gyroscope, etc. The promoter user data may or may not be associated with the vehicle data of at least one of the vehicles available for the trial. The one or more processors provided in the customer's user terminal are configured to build the customer user data of the respective customer. The customer user data includes, among other information, a customer driving profile, which is based on the set of operating parameters. At least some of the set of operating parameters based on one or more operating parameter values collected from one or more sensors provided in the respective customer's user terminal, such as a GPS sensor, a magnetometer, an accelerometer, a gyroscope, etc. The system includes a search engine for identifying vehicles satisfying a search query from at least one of the customers, wherein the search query includes a condition structured to compare the customer's driving profile and the usage profiles of the vehicles for the match (at least satisfying a threshold similarity). The search engine may be provided on a remote server with one or more databases storing a plurality of vehicle data and a plurality of user data for the promoters and customers. Alternatively, the search engine may be provided on each of the user terminals for the promoters and the customers. The one or more processes of the promoter's user terminals and the customer's user terminals are configured to schedule a meeting between the customer and the promoter of a vehicle selected by the customer among the identified vehicles. When the one or more processors of promoter's user terminals and/or the customer's user terminals detects an occurrence of the scheduled trial of the vehicle, the vehicle can be put in a presentation mode.

A third illustrative embodiment describes a consumer-assisted vehicle sales system. The system includes a network-based interaction environment including a plurality of peer-to-peer nodes being able to communicate directly with each other using a peer-to-peer protocol and a trial scheduling application provided in each peer-to-peer node. Each peer-to-peer node of the plurality of peer-to-peer nodes is provided with a processor and a memory coupled to the processor for storing vehicle data or customer user data. The first trial scheduling application is configured to maintain persistent vehicle data on at least one peer-to-peer node of the plurality of peer-to-peer nodes. The persistent vehicle data includes a usage profile of a vehicle being offered for a trial by a promoter associated with the first trial scheduling application. The second trial scheduling application is configured to maintain persistent customer user data on at least one other peer-to-peer node of the plurality of peer-to-peer nodes. The persistent customer user data includes a customer driving profile of the customer associated with the second trial scheduling application. The peer-to-peer node maintaining the persistent vehicle data may be a network enabled computing device of a promoter. The peer-to-peer node maintaining the persistent customer user data may be a network enabled computing device of a customer. A search engine can be provided on one or more of the plurality of peer-to-peer nodes (or all of the peer-to-peer nodes for increased stability and resiliency). The search engine enables a search of peer-to-peer nodes for vehicles offered for a trial by the plurality of promoters, which match the search query structured to identify vehicles with the usage profile that is sufficiently similar to the customer's driving profile. The threshold for the similarity sufficiency may be defined, for instance, based on a less/more than predetermined deviation value for certain set of operating parameters, or based on a number of identical set of operating parameters, etc. The search results produced by the search engine is cached on said at least one peer-to-peer node of the plurality of peer-to-peer nodes and made accessible to other peer-to-peer node of the plurality of peer-to-peer nodes. The trial scheduling applications are further configured to send trial request and confirmation between the plurality of peer-to-peer nodes to schedule the trial.

### BRIEF DESCRIPTION OF THE DRAWINGS

FIG. 1 illustrates an exemplary system for assisting vehicle sales.

FIG. 2 is a block diagram of an exemplary vehicle offered for a test drive in the system of FIG. 1.

FIG. 3 is a diagram illustrating an exemplary process of facilitating vehicle sales assistance.

### DETAILED DESCRIPTION OF THE INVENTION

Hereinafter, the present invention will be described in more detail with reference to the following Examples. However, these Examples are set forth to illustrate the present invention, and the scope of the present invention is not limited thereto.

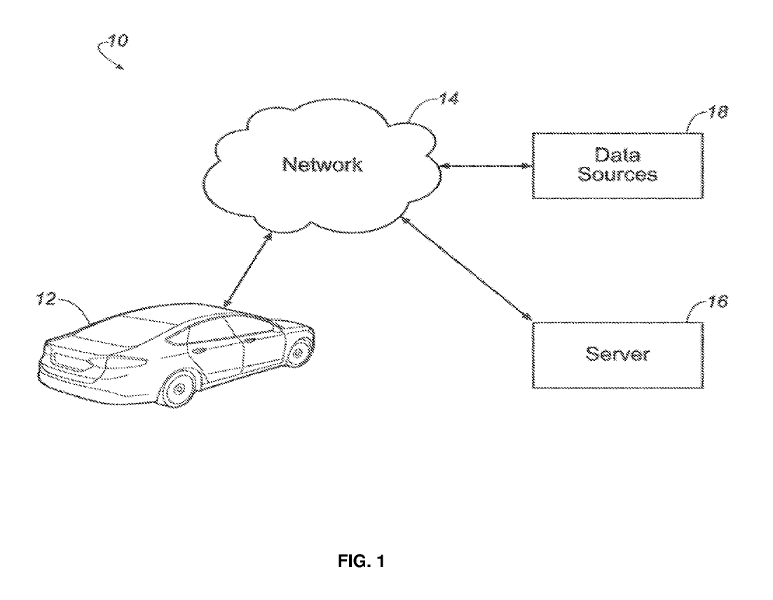

An exemplary system 10 for assisting vehicle sales is shown in FIG. 1. The system 10 includes one or more vehicles 12, a network 14, a server 16, and may further include one or more data sources 18.

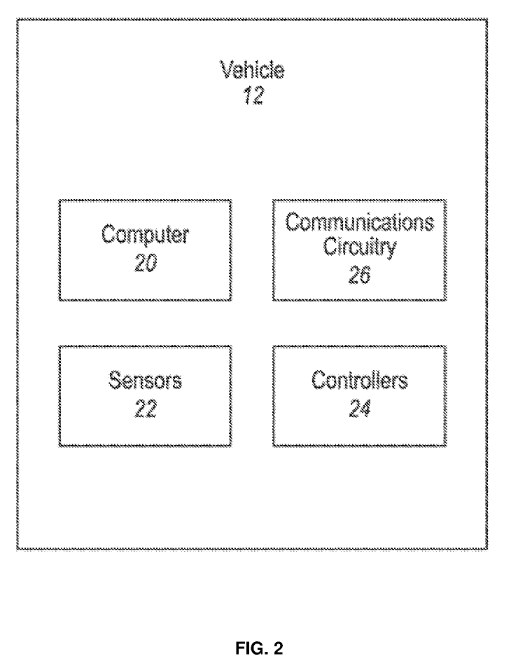

In this disclosure, the vehicle 12 is described as an automobile equipped with wheels to be driven on the ground (e.g., a passenger car). As described in additional detail below, and as seen in FIG. 2, the first vehicle 12 includes a vehicle computer 20. The vehicle computer 20 of the vehicle 12 may be configured to transmit various data to the server 16. The data may include identification data, data from sensors, data from controllers, data received from data sources such as a user terminal (mobile computing device), which may be connected with global positioning systems, weather tracking systems, traffic tracking systems, etc. The vehicle computer 20 may be programmed to perform and/or collect data related to on-board diagnostic (OBD) tests on one or more vehicle sub-systems, as described in additional detail below, and the vehicle 12 may transmit the result of the on-board diagnostic tests to the server 16.

The network 14 represents one or more mechanisms by which the one or more vehicles 12, the server 16 and one or more data sources 18 may communicate with each other, and may be one or more of various wired or wireless communication mechanisms, including any desired combination of wired (e.g., cable and fiber) and/or wireless (e.g., cellular, wireless, satellite, microwave and radio frequency) communication mechanisms and any desired network topology (or topologies when multiple communication mechanisms are utilized). Exemplary communication networks include wireless communication networks, local area networks (LAN) and/or wide area networks (WAN), including the Internet, providing data communication services. In the illustrative embodiment shown in FIG. 1, the vehicle computer 20 of the vehicle uses the BLUETOOTH or WiFi protocol to communicate with a user terminal (e.g., user's mobile network device, such as cell phone, smart phone, PDA, or any other device having wireless remote network connectivity), which serves as a data source 18. The user terminal (data source 18) can then be used to communicate with a network 14 outside the vehicle 12 through a wide area data network (e.g., long-term-evolution, LTE network).

As described above, the data source 18 may be a discrete computing system that is not permanently connected to the vehicle computer 20. The data source 18 may provide data related to an operating condition of the vehicle 12. For instance, the data source 18 may be programmed to generate and provide map data, weather data, geo-coordinates (e.g., latitude, longitude), traffic data, and more, to the one or more vehicles 12 or to the server 16. In the illustrative embodiment shown in FIG. 1, the data source 18 is a user's smartphone, which, in turn, provides connection to various other external data sources such as global positioning systems, traffic tracking systems, weather tracking systems, etc. Likewise, other types of mobile network device having wireless remote network connectivity capable of communicating with information supplying services can act as the data source 18. In some other embodiments, data sources 18 may be one or more remote servers of information supplying services (e.g., map, geographical location, traffic, weather conditions).

The vehicles 12 may be in communication with the server 16 via the network 14. The vehicles 12 may communicate all or some portion of the data collected from the on-board-diagnostic systems, sensors and/or the data sources 18 to the server 16 to facilitate in processing, communication, and storage. The server 16 may utilize data from other data sources 18 to facilitate the vehicle sales assistance process. That is, the server 16 may combine or otherwise process some of the data from the vehicle 12 and the data from the data sources 18 to create another data usable as a parameter for usage profile and/or driving profiles described herein.

The server 16 may include the capability to offer a peer-to-peer (P2P) consumer-assisted vehicle sales platform. A trial scheduling application (referred hereinafter as the “scheduler”) may help depict relationships between the various users (i.e., customers, vehicle owners/promoters, vehicle manufacturer) and/or vehicles 12 to facilitate consumer-assisted vehicle sales system, among other things. The scheduler may indicate the relationship between customers of vehicle manufacturers who are looking for vehicles available for a test drive, the vehicle owners who are willing to offer his/her vehicles for test drive (the “promoters”), the vehicles 12 available for test drive, and potential meeting-spots for the customers and the promoters to test drive the vehicles 12.

Although the consumer-assisted vehicle sales system 10 depicted in FIG. 1 includes the server 16, it should be noted that the server 16 is not necessary and may not be included in other embodiments of the consumer-assisted vehicle sales system. As will be described in further detail below, the scheduler may be provided in the vehicle computer 20, the customer's user terminal and the promoter's user terminal in the embodiments of the consumer-assisted vehicle sales system 10 without the needs for having a scheduler in the server 16.

The scheduler may utilize various data, including user data associated with the customers and vehicle data associated with the vehicles available for a trial (e.g., test drive). The vehicle data may include vehicle identification data as well as usage profile data. The vehicle identification data includes information such as vehicle model, vehicle manufacturing year, vehicle features, vehicle performance specifications, etc. The usage profile is information representative of how a vehicle has been driven. The usage profile is built upon a set of operating parameters of the respective vehicle, in which at least some of those operating parameters are based on the current and/or cumulative data retrieved from one or more on-board sensors equipped in the vehicle.

The user data may include user identification data as well as driving profile data. The user data can be categorized into a customer user data and a promoter user data, depending on the user's role in the system. The user identification data includes personal identification information such as name, location, driver's license information, insurance information and the likes. The driving profile of the user (the customer and the promoter) is information representative of the user's driving style as well as the usual conditions the user drives. The driving profile of the users is built upon a set of operating parameters, in which at least some of those operating parameters are based on the current and/or cumulative data retrieved from one or more sensors provided in the user terminal. The sensors provided in the user terminal may include a GPS sensor, a magnetometer, an accelerometer, a gyroscope, as well as any other sensors that are provided in personal mobile computing device of the current or future generations.

Data utilized by the scheduler may further include data concerning operating conditions and diagnostic data representative of measured parameter values for one or more diagnostic tests related to and/or performed by the vehicle 12. Current operating condition data may include data such as the location of the vehicle 12, weather conditions during operation (e.g., environmental conditions such as outside temperature, humidity, etc.), positions of actuators (e.g., in controllers) in the vehicle 12, electric current applied to a motor in the vehicle 12, etc. Diagnostic data includes results of diagnostic tests performed by the vehicle 12 such as, a vapor pressure level or a fluid pressure level. Some data may be obtained from the vehicles 12 while some data may be obtained from other data sources 18 such as global positioning systems, traffic reporting systems, weather reporting systems, etc.

In some embodiments, the server 16 may communicate directly with such external global positioning systems, traffic reporting systems, weather reporting systems, etc. In some other embodiments, the vehicle computer 20 or a user terminal (e.g., smartphone) may be configured to communicate with such external global positioning systems, traffic reporting systems, weather reporting systems, etc., and forward the data retrieved from those external systems to the server 16.

The aforementioned data may be collected, e.g., via a network 14. The types of wireless communications may include, local area network communication such as Bluetooth and WiFi interface as well as wide area network communication interface (e.g., cellular, 3G, 4G, 5G network). In some embodiments, the data source 18 is coupled to a wide area network and the vehicle computer 20 is configured to communicate with the data source 18 via a local area network communication interface. In this way, the vehicle computer 20 can communicate with the vehicle computer of another vehicle, with the server 16, and/or with another data source (other than the one that is providing WAN connection) via the wide area network of the data source 18. In some other embodiments, the communication circuitry 26 coupled to the vehicle computer 20 includes a WAN communication interface providing a direct WAN accessibility to the vehicle computer 20 without the intermediate connection to the data source 18.

The vehicle computer 20 includes a processor and a memory. The memory includes one or more types of computer-readable media, and storing instructions executable by the processor for performing various operations, including as disclosed herein. Further, the vehicle computer 20 may include and/or be communicatively coupled to one or more other computers, including but not limited to, various vehicle components such as the sensors 22, and controllers 24, which likewise as is known may include respective processors and memories. Communications may be performed, for example, via a controller area network (CAN) bus or local interconnect network (LIN) bus, etc., as is known. As will be described in further detail below, the vehicle computer 20 may be programmed to perform diagnostic tests and determine the operability of on-board systems such as on-board sensors 22, on-board controllers 24, and the on-board communications circuitry 26.

One or more sensors 22 are provided in the vehicle 12 to collect various data related to the vehicle 12 and the environment in which the vehicle 12 is operating under. The vehicle computer 20 may use the data received from one or more sensors 22 to assess the condition of the vehicle 12. By way of example, and not limitation, the sensors 22 may be an on-board-diagnostics system, thermometers, barometers, humidity sensors, altimeters, cameras, lidar, radar, ultrasonic sensors, infrared sensors, pressure sensors, accelerometers, gyroscopes, temperature sensors, hall sensors, optical sensors, voltage sensors, current sensors, mechanical sensors such as switches, etc. The sensors 22 may be used to sense the environment in which the vehicle 12 is operating such as weather conditions, the grade of a road, the location of a road, neighboring vehicles 12, etc. The sensors 22 may further be used to collect dynamically changing vehicle data related to operations of the vehicle 12 such velocity, yaw rate, steering angle, engine speed, brake pressure, oil pressure, the power level applied to controllers in the vehicle, connectivity between components, etc. The sensors 22 may still further be used to measure parameters and generate parameter values related to one or more diagnostic tests, such as fuel level, evaporative emissions pressure, etc.

The communications circuitry 26 may include hardware, software, firmware, etc., such as are known, and may be configured for one or more types of wireless communications. The hardware may include, e.g., one or more transceivers, one or more receivers, one or more transmitters, one or more antennas, one or more microcontrollers, one or more memories, one or more electronic components etc. The software may be stored on a memory, and may include, e.g., one or more encoders, one or more decoders, etc. for converting messages from one protocol to another protocol. Some functions, e.g., encoding functions, may be realized via firmware. Additionally, the communications circuitry 26 may be communicatively coupled to the vehicle computer 20 via, e.g., a wired network such as a controller area network (CAN) bus or local interconnect network (LIN) bus, as is known.

The one or more controllers 24 for the vehicle 12 may include known electronic control units (ECUs) or the like including, as non-limiting examples, an engine controller, a valve controller, a seat controller, a power steering controller, a door lock controller, a door latch controller, a climate controller, a mirror adjustment controller, a seatbelt controller, a brake controller, etc. Each of the controllers 24 may include respective processors and memories, one or more actuators, and may send instructions to and/or receive data from one or more sensors 22. The controllers 24 may be programmed and connected to a vehicle 12 communications bus to receive instructions from the vehicle computer 20 and control an actuator based on such instructions. For example, a valve controller may receive an instruction to open or close a valve and may cause an actuator to displace a valve cylinder. The actuator may be, for instance, a motor or a solenoid. One or more sensors 22 may be configured to detect the action of the actuator. By way of example, a sensor 22 in the valve controller may detect that the valve cylinder has been displaced, and the controller 24 may provide data regarding the status of the valve cylinder to the computer 20.

The vehicle computer 20 of the vehicle 12 is configured to collect one or more of vehicle data from the respective vehicle 12. The vehicle data may include information describing a vehicle's location, a vehicle's speed, a vehicle's acceleration, a vehicle's direction as well as a vehicle's orientation (i.e., relative to a horizontal and/or vertical plane). Vehicle data may also include information about the state of one or more components of the vehicle. For example, vehicle data may include data describing the vehicle's engine's revolutions per minute (RPM), the heat of the vehicle's engine, information describing whether or not a vehicle's headlights or windshield wipers are in operation, information describing the tire pressure in the vehicle's tires, information describing the amount of fuel in the vehicle's gas tank, etc.

The vehicle data may further includes usage profile data describing how the vehicle 12 has been driven for a given period of time. For instance, the usage profile may include information as to the usage patterns of the vehicle 12 (highway driven to local road driven ratio, starting and stopping in heavy traffic, a speed profile along a path of travel, an acceleration profile after a stop and during high-speed driving, a deceleration profile, break frequency during high-speed driving, number of road bumps along the traveled path, etc.). Not only does the usage profile of the vehicle data provides information as to how the vehicle 12 has been driven, but the data also provides some linkage to the information on the driving behavior of the vehicle owner (presumably the promoter), thereby allowing a customer to find vehicles that have been driven under the condition similar to the condition as if the vehicle would have been driven by the customer. In other words, the system 10 can utilize the usage profile and the customer's driving profile to find vehicles, which have been driven in a similar day-to-day driving condition as the customer's day-to-day driving condition and/or by a promoter who has a similar driving behavior as the customer. In this way, the customer can have an indirect experience on how a vehicle would perform as well as how the wear and tear conditions of a vehicle would be like, if the customer purchases a new vehicle (of a similar class from the same maker) and drives it for a similar time period as the test driven vehicle.

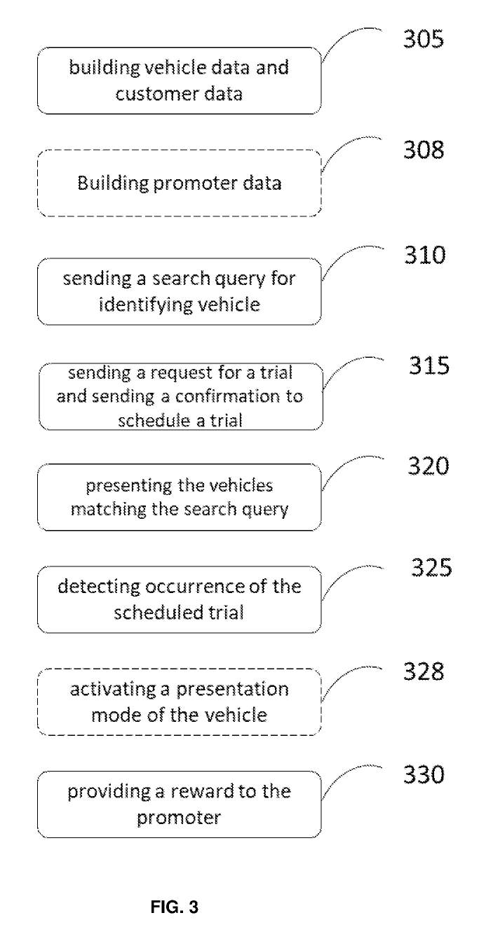

FIG. 3 is a diagram of an exemplary process 300 for facilitating vehicle sales assistance. In block 305, the scheduler collects data relating to the users of the system 10 and the data relating to the vehicles 12. The data relating to the users of the system 10 includes the user data for each of the potential vehicle purchasers (i.e., customers) who wishes to test drive vehicles 12 and the user data for each of the individuals who wishes to offer his/her vehicle 12 for test drive (promoters). The user data for the customers may include personal identification information such as name, location, driver's license information, insurance information and the likes. As described above, the user data for the customers may also include driving profile information, for instance, frequent driving routes (e.g., home to work route), frequent driving time of the day/season, average driving speed, acceleration style from stationary to a predetermined cruising speed(s), deceleration style from a predetermined cruising speed(s) to a full stop, and the likes. It should be noted that the driving profile information of the customer is not limited to the foregoing, but may include various other information representative of driving behavior, style and/or driving conditions of each respective customer using the consumer-assisted vehicle sales system 10.

The user data for the customers can be obtained from the customer's terminal (e.g., a PC, smartphone, tablet and/or other personal computing devices). Some types of user data, for instance personal identification information, may be manually supplied by the customer. The customer may manually supply information necessary to build the driving profile using a personal computer, for instance, by answering a set of questionnaire. Also, the information for building the driving profile of the potential vehicle purchaser may be automatically gathered. For instance, a version of the scheduler for the customer may be provided within a customer's user terminal (e.g., smartphone), and the scheduler can be configured to assess/record the driving behaviors and driving conditions of the respective user by using various sensors (e.g., a GPS sensor, a magnetometer, an accelerometer, a gyroscope, etc.) included in the customer's user terminal. If the customer's user terminal can communicate to the customer's own vehicle, then the scheduler may be configured to obtain some of the data from the vehicle computer, telematics system and/or sensors provided in the customer's vehicle. When the scheduler detects the customer being in a moving vehicle, the scheduler may be configured to identify whether the potential vehicle purchaser is the one who is driving the vehicle. In this regards, the scheduler may prompt a message asking to confirm if the customer is currently driving the vehicle. The scheduler can also be configured to assume that the customer is the driver if the customer's user terminal is connected to the vehicle computer and/or to the other telematics system of the moving vehicle. This way, the driving profile data of the customers can be created and updated. Further, the scheduler may be configured to build the driving profile from the information manually supplied by the customers. For instance, the customer can supply the home address and the work address (or other frequently visited places), and the scheduler may identify the distance, road conditions and/or traffic conditions of the routes (at a certain time of the day). The customer may also give permission to the scheduler to access other data sources 18 (e.g., applications included in the smartphone) such as the map/navigation service system, traffic information service system and the likes.

In the embodiment shown in FIG. 1, the user data including the driving profile data of each of the customers is sent to the server 16 via the network 14. In a peer-to-peer network based consumer-assisted vehicle sales system, the user data including the driving profile of each individual customer can be stored in the respective customer's user terminal along with the scheduler.

The user data of the promoters may be obtained in a similar fashion as the user data of the customers (step 308). In case of the promoter's user data, however, the user data may include the vehicle identification data of the vehicle 12 associated with the promoter, such as vehicle identification data, make, model and year of the vehicle 12 as well as optional features, trim and package equipped in the vehicle 12.

The scheduler for the promoter may be provided in the vehicle computer 20 of the vehicle 12 or may be provided in the user terminal (e.g., smartphone) of the promoter, which can be connected to the vehicle computer 20 of the vehicle offered for a trial by the customers. The driving profile of the promoter is likely to be closely related to the vehicle 12 being offered for the trial. Thus, the driving profile of the promoter can be utilized by the scheduler in identifying vehicles 12 matching the search criteria of the customer. Nevertheless, it is important to note that the driving profile of the promoter is used as a secondary source of data for identifying the vehicle driven in the condition similar to that of the customer. Accordingly, the data obtained from the on-board vehicle computer, telematics system and the on-board sensors of the vehicle 12 should be weighed more than the data obtained from the user terminal of the promoter when finding a vehicle for the customer.

For example, the most frequently traveled route of the vehicle 12 identified by the vehicle computer 20 according to the GPS of the vehicle 12 should be preferred over the most frequently traveled route identified based on the GPS data from the promoter's user terminal. The most frequently traveled route identified by the vehicle computer 20 is the most frequently traveled route specific to the vehicle 12, whereas the most frequently traveled route identified from the promoter's user terminal may be the most frequently traveled route of the promoter. Since one of the objects of the consumer-assisted vehicle sales system 10 is to provide an opportunity to test drive a vehicle that has been driven in the similar driving style and under the similar driving condition of the customer himself, the data that is associated directly with the vehicle 12 is more valuable and relevant for the purpose than the data obtained from the secondary sources such as the promoter's user terminal. Nevertheless, in case where the vehicle 12 lacks some sensors and unable to collect parameter values among the set of operating parameter values included in the usage profile of the vehicle 12, then the parameter values corresponding to such missing parameter values of the set of operating parameters can be supplemented from the data within the driving profile of the promoter associated with the vehicle for improved accuracy in identifying the ideal vehicle for the customers.

Some of the aforementioned information may be the current information at the time of the measurement. Some of the aforementioned information may be processed data from the data gathered over a period of time. For example, the vehicle data may include the current location of the vehicle as well as the frequently traveled routes of the vehicle, which may be identified from the series of location tracking data obtained during each trip of the vehicle 12. The vehicle data may include the current travel speed of the vehicle as well as the average travel speed of the vehicle during a predetermined period of time and/or for the travel on the frequently traveled routes. Further, the vehicle data may include average vehicle's engine's revolutions per minute (RPM) during acceleration from a stop to a predetermined (ranges of) speed and/or the time taken to reach a predetermined (ranges of) speed. Also, the vehicle data may include the (average) rate of decrease in the speed between certain speed ranges and to a full stop. In some embodiments, the data obtained from the sensors 22 of the vehicle 12 and the data obtained from the sensors of the user terminal may be used in combination to provide more complete set of vehicle data and/or to improve the accuracy of the vehicle data. For instance, the RPM information may be obtained from the relevant sensor 22 of the vehicle 12 while acceleration to a predetermined speed may be obtained from the accelerometer provided in the smartphone of the vehicle owner connected to the vehicle computer 20. A scheduler in either the vehicle computer 20 or the smartphone may combine the two types of data to create an acceleration profile data of the vehicle 12 usable by the vehicle sales assistance system 10.

In addition, vehicle data may include information about the state of one or more components of the vehicle. For example, vehicle data may include data describing the vehicle's engine's revolutions per minute (RPM), mileage, the temperature of the vehicle's engine and/or other components, information describing whether or not certain components of a vehicle are in operation, information describing the tire pressure in the vehicle's tires, information describing the amount of fuel in the vehicle's gas tank, and other diagnostic/status information provided from on-board diagnostic system.

As mentioned above, some of the aforementioned vehicle data may also be obtained by the one or more sensors provided in the promoter's user terminal, which may serve as the data source 18 itself or connected to other data sources 18. For example, more detailed data regarding the condition of the vehicle 12 may be stored in the service center's data server (e.g., data source 18) albeit the data may not be the most up-to-date data. Nevertheless, the diagnostic data of the vehicle 12 from the service center may serve as an important factor when it comes to identifying a vehicle for the test drive because such data can indicate how well the maintenance of the vehicle has been kept. From the perspective of the vehicle manufacturer, test drive experience from a poorly maintained vehicle may be worse than not providing the test drive experience at all. Accordingly, vehicles 12 not meeting a minimum maintenance requirement may be filtered from the pool of vehicles available for test drive.

In some embodiments, the scheduler may be programmed to collect a set of data related to a particular diagnostic test performed by respective vehicles 12. The vehicle computer 20 of a vehicle 12 may be programmed to perform one or more on-board diagnostic (OBD) tests. The vehicle computer 20 may test for the proper operation of a particular component or group of components in the vehicle 12. The vehicle computer 20 may initiate a diagnostic test, periodically or upon certain milestone event, by sending instructions to one or more controllers 24. The controllers 24 may put the vehicle 12 in a condition to perform the diagnostic test. That is, one or more vehicle components can be actuated and/or controlled in a predetermined manner and/or to be in a predetermined position for the test. The condition may include, for example, placing one or more valves in particular positions, applying a particular of force by a motor, activating/deactivating various components such as wipers, air conditioning system, and the likes that do not require special diagnostic equipment. Upon placing the vehicle 12 in the condition to perform the diagnostic test, the vehicle computer 20 may receive data from one or more sensors 22. Based on the data from the sensors 22, the vehicle computer 20 can confirm whether a value of a measured test parameter is within a predetermined range. The parameter value being within the predetermined range may indicate that the component being tested by the vehicle computer 20 is operating within specification. The parameter value being outside of the predetermined range may indicate that the component being tested is not operating within specification, in which case the vehicle 12 may be filtered from the pool of vehicles available for test drive.

The set of diagnostic data may include the identification data related to the vehicle 12, the operating conditions related to the vehicle 12 at a time of the diagnostic test, and the one or more test parameter values measured by the vehicle 12 during the diagnostic test. By way of example, the vehicle computer 20 may perform a diagnostic test to detect leaks in an evaporative emissions (EVAP) system. The first vehicle computer 20 may actuate one or more vehicle components under control of the vehicle computer 20. Actuating a vehicle component under control of the vehicle computer 20 may include a vehicle computer 20 sending instructions via a vehicle communications bus to a vehicle controller 24 (e.g., electronic control unit or “ECU”), and the vehicle controller 24, based on the instructions, actuating a component in the vehicle 12. For example, in order to perform the diagnostic test, the vehicle computer 20 may actuate a valve to open or close a fuel vapor cavity within the vehicle 12. The vehicle computer 20 may send an instruction to a valve controller 24. The valve controller 24 may control an electric motor to open or close the valve. The valve controller 24 may further provide feedback to the vehicle computer 20 indicating that the valve is in the open or closed position. Non limiting examples of diagnostic tests that can be performed without external diagnostic equipment include manifold pressure sensing diagnostics, engine coolant temperature sensing diagnostics, fuel injection system diagnostics, knock sensor diagnostics, exhaust gas recirculation function diagnostics, catalyst system efficiency, function diagnostics.

In the exemplary embodiment shown in FIG. 1 includes a server 16, and the user data, driving profiles, vehicle data, usage profile described above may be collected by the server 16. The user data as well as the driving profile of the users are personal information, which should be kept in confidence. Even with various security measures, gathering all of those data into a central server 16 still poses a great security risk, which in turn may involve critical legal and financial consequences. Accordingly, in other embodiments, the user data including the driving profile and the vehicle data including the usage profile relevant to the vehicle 12 may be stored in the vehicle computer 20 of the vehicle 12 and/or the personal computing device of the promoter. The user data and the driving profile data of the customer may be stored in the user terminal of customer. Each of the vehicle computers 20 and the user terminals serves as a “peers” or a “node” of a P2P consumer-assisted vehicle sales system 10. In other words, each user's personal data is stored in the respective user's own personal device, at least until the data is used to identify the test drive vehicles matching search query of the customer.

Referring back to FIG. 3, in block 310, a customer sends a search query for identifying a pool of trial vehicles matching the search query. The search query can be formed of a set of data collected by the scheduler of the customer. In block 315, vehicles matching or otherwise satisfying the search query are identified and provided to the scheduler of the customer who sent the search query.

By way of example, the search query may include make and model of a vehicle, driving profile of the potential vehicle purchaser, and the current location of the customer. The scheduler may be configured to identify a group of vehicles of the specified make and model. The group of vehicles may be sorted in the order of which the vehicles with a similar usage profile as the driving profile of the customer are prioritized. In other words, the vehicles that have been driven with a usage pattern similar to the customer's usage pattern are provided to the scheduler of the customer for a selection. As described above, the usage profile can include various types of information, for example, the number of hours or miles driven per day, road conditions of the most frequently driven routes, acceleration/deceleration profile, and other information representative of the factors and conditions in which the vehicle has been driven under. The driving profile regarding the customer can be gathered from the customer's user terminal or his own vehicle, both of which may be equipped with one or more sensors. The usage profile regarding the trial vehicle can be gathered from the vehicle's telematics system, vehicle computer 20 as well as the user terminal of the promoter. Accordingly, the categories of the set of operating parameter values included the usage profile of the vehicle and the driving profile of the customer/promoter can be the same, albeit parameter values in some of the parameters may be missing due to the lack of sensors in the vehicle and the user terminals.

The group of vehicles may further be sorted or filtered according to the distance between the vehicle 12 and the customer, which can be calculated from the location data of the vehicle and the customer. Of course, the distance between the customer and the test drive vehicle can be prioritized over the matching score (i.e., similarity) between the driving profile of the customer and the usage profile of the test drive vehicle.

As described above, in some embodiments, the group of vehicles may be filtered based on the vehicles maintenance status data, which may be obtained from a remote server of a service center or collected from diagnostic tests performed by the scheduler provided at the promoter's side (i.e., the scheduler provided in the vehicle computer 20 or the promoter's user terminal).

In block 320, a request for a trial is sent to the scheduler of the promoter of the vehicle upon selection of a vehicle by the customer. By way of example, a list of vehicles satisfying the threshold for search query may be presented on the user terminal of the respective customer. The scheduler provided on the customer's user terminal may provide a suitable graphical user interface for selecting one or more of vehicles, propose time and meeting location for test drive, and configured to send an alert to the schedulers of promoters of those selected vehicles to either accept or reject the test drive request. Acceptance of the request by the promoter will schedule a test drive.

In some embodiments, request for test drive may not be sent to the promoters immediately upon finding of matching vehicles by the customer. Instead, the vehicles identified to be meeting the threshold based on the search criteria may be stored in the user terminal of the customer. Then, the scheduler can be configured to send a request for a test drive when a vehicle satisfying the search query is within a predetermined distance from the customer. The alert may be provided to both the customer and the promoter, and the meeting is scheduled when both sides accept the request or otherwise indicate their willingness to meet for a test drive of the vehicle 12.

In block 325, the occurrence of test drive may be verified. In other words, the consumer-assisted vehicle sales system 10 may verify if the scheduled test drive is actually followed through. Verification may be performed in many different ways. For instance, the occurrence of the test drive can be verified when the customer's user terminal provided with the scheduler is present within a predetermined distance from the test drive vehicle. The verification can be made when the user terminal of the customer is linked to the vehicle computer 20 of the vehicle 12 via wired or wireless connection. Verification by connection between the customer's user terminal and the vehicle computer 20 of the vehicle 12 is preferred.

When the test drive incident is verified, the vehicle computer 20 of the vehicle 12 may be configured to activate a presentation mode of the vehicle 12 (step 328). The presentation mode may be a special operating mode of the vehicle 12 prepared for test driving events. For instance, configurable settings of the vehicle 12 may be temporarily reset to the default setting or to the settings preferred by the customer, which may be provided from the scheduler of the user terminal of the customer when it is connected to the vehicle computer 20 of the vehicle 12. By way of example, seating position, air conditioning system as well as setting relevant for driving mode of the vehicle 12 can be automatically adjusted to mimic the settings preferred by the customer.

It should be noted that the promoter is not intended to be a car sales agent employed by the vehicle manufacturer. Instead, the system 10 is intended to utilize general consumers who already purchased a vehicle to use his own vehicle to provide a test drive to a potential new vehicle purchaser. Accordingly, the promoter offering his vehicle for test drive may not be fully knowledgeable regarding the vehicle 12. Accordingly, in some embodiments, the vehicle computer 20 of the vehicle 12 may initiate a guided test drive program upon verifying the occurrence of the scheduled test drive. A vehicle equipped with vehicle computer 20 may be provided with a control interface panel for the user to interact with the interface and access features provided by the vehicle. The control interface panel coupled to the vehicle computer 20 may be a touch sensitive screen. Interaction with the control interface panel may also occur through button presses, spoken dialog system with speech recognition feature. The guided test drive program can present an audio-visual presentation, which will guide the customer through the test drive in a preset sequence. During the guided test drive program, the vehicle computer 20 can actuate/control the controllers 24 of the vehicle 12 to explain available features of the vehicle 12.

In block 330, upon verification of test drive, a form of reward may be provided to the scheduler of the promoter as compensation for offering his vehicle for test drive. The rewards may, but need not, be in the form of monetary compensation. For example, certain points or coupons for free maintenance of the vehicle may be provided electronically to the scheduler provided in the vehicle computer 20 and/or in the user terminal of the promoter. The amount of rewards may vary depending on whether the customer ended up purchasing a vehicle made by the vehicle manufacturer of the test driven vehicle 12. Further, the rewards may vary based on the maintenance condition of the vehicle used in the test drive or the survey result from the customer submitted after the test drive.

Computing devices such as those discussed herein generally each include instructions executable by one or more computing devices such as those identified above, and for carrying out blocks or steps of processes described above. For example, the scheduler for the customer, the scheduler for the promoter (i.e., the scheduler provided in the user terminals or provided in the vehicle computer 20 of the vehicle 12) as well as the scheduler provided in the server 16 discussed above may be embodied as computer-executable instructions. Likewise, the process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions from a memory or a computer-readable medium, and executes these instructions, thereby performing one or more processes, including one or more of the processes described herein. In an illustrative embodiment, the personal computing devices of users are mobile computing devices such as smartphone or tablets running Android or iOS operating systems, and the scheduler mentioned above is an application that runs on Android or iOS operating systems. Similarly, the vehicle computer 20 may be a system implemented with the Android or iOS operating system, and the scheduler provided in the vehicle computer 20 is an Android or iOS compatible application. The scheduler provided in such mobile computing device of the user may be configured and operated in different modes based on whether the user is using the application in the capacity of a customer or in the capacity of a promoter offering his own vehicle for test drive. In the embodiments utilizing the server 16, the scheduler to be provided in the server 16 may be different from the scheduler to be installed in the user terminal of the individual users. In particular, the scheduler to be installed in the server 16 should be able to communicate with the schedulers provided on both the customer side and the promoter side to receive data to facilitate the consumer-assisted vehicle sales system 10.

Such instructions and the various data described herein may be stored in files and transmitted using a variety of computer-readable media. A file in a computing device is generally a collection of data stored on a computer readable medium, such as a storage medium, a random access memory and the likes.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a reference to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

What is claimed is:

1. A method of operating a consumer-assisted vehicle sales platform, comprising the steps of:
building vehicle data for each vehicle available for a trial, the vehicle data comprising a usage profile including a set of operating parameters of the respective vehicle, which, at least in part, based on one or more operating parameter values collected from one or more on-board sensors of the respective vehicle;
building customer user data for each customer, the customer user data comprising a customer driving profile including the set of operating parameters, which, at least in part, based on one or more operating parameter values collected from one or more sensors of the respective customer's user terminal;
identifying vehicles satisfying a search query from at least one of the customers, wherein said search query includes a condition representative of similarity between the customer's driving profile and the usage profiles of the vehicles;
transmitting a request for trial to a promoter's user terminal associated with at least one of the identified vehicles and transmitting an acceptance to a user terminal of the customer who requested the trial to schedule the trial.

2. The method of claim 1, further comprising a step for:
building promoter user data for each promoter, said promoter user data comprising a promoter driving profile including the set of operating parameters, which, at least in part, based on one or more operating parameter values collected from one or more sensors of the respective promoter's user terminal, wherein the promoter user data is associated with the vehicle data of at least one of the vehicles available for the trial.

3. The method of claim 2, wherein said search query for identifying vehicles further includes a condition representative of similarity between the customer's driving profile and the promoter's driving profile.

4. The method of claim 2, further comprising a step for:
supplementing the set of operating parameters of the usage profile of the vehicle from the set of operating parameters of the promoter's driving profile associated with the respective vehicle.

5. The method of claim 1, wherein the set of operating parameters comprises one or more parameters indicative of basic operation profile, frequently traveled road profile, acceleration profile, deceleration profile, velocity profile and maintenance profile.

6. The method of claim 1, wherein the customer user data includes a vehicle setting profile of the respective customer, and wherein one or more adjustable settings of the vehicle being used for the trial are automatically adjusted by one or more controllers of said vehicle based on the vehicle setting profile of the respective customer upon detecting an occurrence of the trial of the vehicle.

7. The method of claim 1, wherein, upon detecting an occurrence of the trial of the vehicle, the vehicle being used for the trial is put in a presentation mode in which one or more adjustable settings of the vehicle are automatically adjusted to predetermined settings by one or more controllers of said vehicle.

8. The method of claim 7, wherein the presentation mode is activated by at least one of detection of the customer's user terminal by a vehicle computer of the vehicle, a network connection between the customer's user terminal and the vehicle computer of the vehicle, detection of the customer's user terminal by the promoter's user terminal, and an onset of an activation command from the customer's user terminal, promoter's terminal or the vehicle computer of the vehicle.

9. The method of claim 1, wherein, upon detecting an occurrence of the trial of the vehicle, a guided trial program is started to guide the customer through a predetermined sequence of trial phases.

10. The method of claim 1, further comprising a step for providing a reward to the promoter upon verifying of an occurrence of the trial.

11. The method of claim 2, wherein the vehicle data of each vehicle and the user data for each customer are stored in a remote database server, the remote database server being configured to perform said identification of vehicles satisfying the search query.

12. The method of claim 2, wherein the promoter's user data and the vehicle data of the vehicle associated with the promoter's user data are stored in the promoter's user terminal that is configured to communicate with a vehicle computer of the vehicle, the customer's user data is stored in the customer's user terminal, each of said promoter's user terminal and each of said customer's user terminal are configured to act as a node in a peer-to-peer network, and wherein the identification of vehicles satisfying the search query is performed by running the search query on each of said promoter's user terminal.

13. The method of claim 2, wherein the search query includes a condition for matching geographical locations obtained from the customer's user terminal and the promoter's user terminal.

14. The method of claim 2, further comprising steps for:
recognizing from a location of the promoter's user terminal and a location of the customer's user terminal; and
providing alerts on the customer's user terminal and the promoter's user terminal indicating opportunities for viewing the vehicle when a distance between the customer's user terminal and the promoter's user terminal is within a predetermined range of distance.

15. A consumer-assisted vehicle sales system, comprising:
one or more network interfaces, wherein each network interface communicates with a customer's user terminal and a promoter's user terminal; and
one or more processors provided in said customer's user terminal and said promoter's user terminal, wherein said one or more processors are configured to:
building vehicle data for each vehicle available for a trial, the vehicle data comprising a usage profile including a set of operating parameters of the respective vehicle, which, at least in part, based on one or more operating parameter values collected from one or more on-board sensors of the respective vehicle;
building customer user data for each customer, the customer user data comprising a customer driving profile including the set of operating parameters, which, at least in part, based on one or more operating parameter values collected from one or more sensors of the respective customer's user terminal;
building promoter user data for each promoter, said promoter user data comprising a promoter driving profile including the set of operating parameters, which, at least in part, based on one or more operating parameter values collected from one or more sensors of the respective promoter's user terminal, wherein the promoter user data is associated with the vehicle data of at least one of the vehicles available for the trial;
identifying vehicles satisfying a search query from at least one of the customers, wherein said search query includes a condition representative of similarity between the customer's driving profile and the usage profiles of the vehicles;
schedule a meeting between the customer and the promoter of a vehicle selected by the customer among the identified vehicles; and
configuring the vehicle to operate in a presentation mode when detecting an occurrence of the scheduled trial of the vehicle.

16. The consumer-assisted vehicle sales system of claim 15, wherein the set of operating parameters comprises one or more parameters indicative of basic operation profile (mileage, distance per trip, weather condition), frequently traveled road profile (highway/local, road bumps/hills, traffic), acceleration profile, deceleration profile, velocity profile (global/per routes) and maintenance profile (diagnostic/checkup frequency).

17. The consumer-assisted vehicle sales system of claim 16, wherein the presentation mode is activated by at least one of detection of the customer's user terminal by a vehicle computer of the vehicle, a network connection between the customer's user terminal and the vehicle computer of the vehicle, detection of the customer's user terminal by the promoter's user terminal, and an onset of an activation command from the customer's user terminal, promoter's terminal or the vehicle computer of the vehicle.

18. The consumer-assisted vehicle sales system of claim 17, wherein said search query for identifying vehicles further includes a condition representative of similarity between the customer's driving profile and the promoter's driving profile.

19. A consumer-assisted vehicle sales system, comprising:
a network-based interaction environment including a plurality of peer-to-peer nodes being able to communicate directly with each other using a peer-to-peer protocol and a trial scheduling application, each peer-to-peer node of the plurality of peer-to-peer nodes including a processor and a memory coupled to the processor for storing vehicle data or customer user data;
a first trial scheduling application to maintain persistent vehicle data on at least one peer-to-peer node of the plurality of peer-to-peer nodes, the persistent vehicle data comprising a usage profile of a vehicle of a promoter being offered for a trial by the promoter associated with the first trial scheduling application;
a second trial scheduling application to maintain persistent customer user data on at least one other peer-to-peer node of the plurality of peer-to-peer nodes, the persistent customer user data comprising a customer driving profile of the customer associated with the second trial scheduling application; and
a search engine on any one of the plurality of peer-to-peer nodes, the search engine enabling a search of peer-to-peer nodes for vehicles offered for a trial by a plurality of promoters matching a search query representative of similarity between the usage profile and the customer's driving profile, search results produced by the search engine being cached on said at least one peer-to-peer node of the plurality of peer-to-peer nodes and made accessible to other peer-to-peer node of the plurality of peer-to-peer nodes to schedule a trial.

20. The consumer-assisted vehicle sales system of claim 19, wherein each of said usage profile and said customer driving profile comprises one or more parameters indicative of basic operation profile, frequently traveled road profile, acceleration profile, deceleration profile, velocity profile and maintenance profile.
